(19) United States
(12) Patent Application Publication
(10) Pub. No.: US 2026/0003674 A1
(43) Pub. Date: Jan. 1, 2026

(54) TASK GROUPING FOR REINFORCEMENT LEARNING WITH MULTIPLE TASKS

(71) Applicants: ATI TECHNOLOGIES ULC, MARKHAM (CA); ADVANCED MICRO DEVICES, INC., Santa Clara, CA (US)

(72) Inventors: Geoffrey Hikaru Harrison, Toronto (CA); Alexander Walter Cann, Markham (CA); Ian Charles Colbert, San Diego, CA (US); Mehdi Saeedi, Thornhill (CA)

(21) Appl. No.: 18/759,358

(22) Filed: Jun. 28, 2024

(51) Int. Cl. G06F 9/48; G06N 3/092; G06N 3/098

(52) U.S. Cl. CPC G06F 9/4887; G06N 3/092; G06N 3/098

(57) ABSTRACT

To generate reinforcement learning (RL) policies for the multiple tasks performable by a system, a computing device is configured to train an RL model for all tasks of a system to produce a general RL model. For each task, the computing device updates the parameters of the general RL model based on the task to produce a task-specific RL model. Based on comparisons of the general RL model to the task-specific RL models, the computing device determines inter-task similarity scores that represent the impact of a task on other tasks, the impact of other tasks on a task, or both. The computing device then groups the tasks of the system together based on the inter-task similarity scores and generates a task-grouped RL policy for each group of tasks.

### BACKGROUND

Certain systems such as robotic systems, manufacturing systems, and other autonomous systems are configured to perform a variety of different tasks. As an example, a robotic system is configured to perform tasks such as lifting items, placing items, manipulating items, throwing items, and the like. To help perform these tasks, some of these systems implement a trained multi-task reinforcement learning (RL) model configured to perform the different tasks of the system based on corresponding inputs. For example, such a trained RL model includes a set of shared parameters that includes weights, biases, and cluster centroids used by the trained RL model to perform different tasks based on corresponding inputs. However, training an RL model to perform these different tasks increases the likelihood that one or more of the tasks introduces interference in the shared parameters, negatively impacting the performance of other tasks by the trained RL model.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a Reinforcement Learning (RL) policy generation system configured to train and distribute task-grouped RL policies, in accordance with some embodiments.

FIG. 2 is a flow diagram of an example operation for generating task-grouped RL policies, in accordance with some embodiments.

FIG. 3 is a diagram of an example operation for grouping tasks based on inter-task similarities, in accordance with some embodiments.

FIG. 4 is a block diagram of an example implementation system configured to perform multiple tasks based on one or more task-grouped RL policies, in accordance with some embodiments.

FIG. 5 is a flow diagram of an example method for generating task-grouped RL policies based on inter-task similarities, in accordance with some embodiments.

### DETAILED DESCRIPTION

Systems and techniques disclosed herein include an implementation system configured to perform a plurality of tasks such as an imaging system, a robotic system, manufacturing system, gaming system, distributed-learning system (e.g., federated learning system), autonomous vehicle system, diagnostic system, and the like. For example, a robotic system including a robotic arm is configured to perform multiple tasks such as placing, picking up, using, and removing different types of objects. As another example, a gaming system executing a game client is configured to perform various tasks for a game such as determining the actions of non-player characters, difficulty scaling, interpreting user interactions, frame rendering, and the like. As yet another example, a distributed learning system includes various computing devices (e.g., nodes) each configured to perform a corresponding task (e.g., training a model for a task) based on local data, data from one or more other computing devices of the system, or both. To perform these tasks, the implementation system is configured to use reinforcement learning (RL) policies that each include data associated with the performance of one or more tasks by the system. As an example, a RL policy includes one or more trained RL machine-learning models each configured to perform one or more tasks of an implementation system based on corresponding input data. As another example, a RL policy includes data indicating which devices (e.g., nodes) of a distributed-learning system are to train machine-learning models for corresponding tasks associated with the system, which devices within the distributed-learning system are to share data (e.g., parameter updates), or any combination thereof. As yet another example, a RL policy includes data indicating grouped tasks for implementation within transfer learning, incremental learning, lifelong learning, or any combination thereof systems.

To generate these RL policies, the implementation system includes or is otherwise connected to a computing device configured to generate the RL policies using an RL model. For example, to produce a RL policy, the computing device first trains a RL model using training data associated with each task of the implementation system to produce a general RL model configured to perform each task of the implementation system based on corresponding inputs (e.g., inputs from which tasks are inferred, inputs associated with corresponding tasks, or both). For example, the general RL model includes a shared set of parameters such as weights, coefficients, cluster centroids, and the like that are used to perform the tasks based on corresponding inputs. The computing device then provides a RL policy including the general RL model to the implementation system which uses the general RL model to perform tasks. However, training a single RL model to perform each task of an implementation system increases the likelihood of introducing interference in the parameters shared between the tasks, negatively impacting the effectiveness and accuracy of the general RL model.

As such, systems and techniques disclosed herein are directed to a computing device configured to produce one or more task-grouped RL policies. For example, the computing device includes a training circuitry configured to first train an RL model using training data associated with each task associated with an implementation system to produce a general RL model that includes a set of shared parameters used to implement the tasks based on corresponding inputs. Based on the general RL model, the training circuitry then determines one or more inter-task similarity scores between each pair of tasks represented by (e.g., performed by) the general RL model. Such inter-task similarity scores, for example, each represent the impact of a first task associated with the general RL model on a loss value of a second task associated with the general RL model (e.g., on the effectiveness or accuracy of a second task). For example, an inter-task similarly score indicates the impact of a first task's gradient update to the parameters of the general RL model on a loss value associated with a second task.

To determine these inter-task similarity scores, the training circuitry first determines one or more first loss values for each task based on the general RL model and one or more corresponding loss functions (e.g., regression loss functions). The training circuitry then updates the parameters of the general RL model based on training data associated with a first task to produce a first task-specific RL model (e.g., a first updated RL model). As an example, based on a gradient descent function that uses training data associated with the first task, the training circuitry updates one or more parameters of the general RL model to produce a first task-specific RL model. Using the first task-specific RL model and the loss functions, the training circuitry next determines one or more second loss values for each other task (e.g., every task but the first task). For each task, besides the first task, the training circuitry determines a corresponding pairwise inter-task similarity score based on a comparison of the first loss values and the second loss values associated with the respective task. In this way, the training circuitry generates pairwise inter-task similarity scores each indicating the impact of the first task on a corresponding other task associated with the general RL model. After determining the pairwise inter-task similarity scores associated with the first task (e.g., each indicating an impact of the first task on a corresponding other task), the training circuitry updates one or more parameters of the general RL model based on training data associated with a second task of the general RL model to produce a second task-specific RL model (e.g., second updated RL model). Based on the second task-specific RL model and the loss functions, the training circuitry determines pairwise inter-task similarity scores associated with the second task each indicating the impact of the second task on a corresponding task of the general RL model. The training circuitry then continues updating the parameters of the general RL model and determining pairwise inter-task similarity scores in this way for each task associated with the general RL model (e.g., associated with the implementation system).

The training circuitry then groups the tasks associated with the general RL model based on the determined inter-task similarity scores to form one or more task groups. As an example, the training circuitry first averages, for each task, the pairwise inter-task similarity scores associated with the task (e.g., indicating an impact by or on the task) to produce an average inter-task similarity score for the task. Based on the average inter-task similarity scores for each task, the training circuitry groups the tasks together such that the average inter-task similarity score across all tasks is maximized. That is to say, grouping a respective task with one or more other tasks of the general RL model such that the average inter-task similarity score of the task is at a value indicating the maximum positive impact on the task by other tasks, minimum negative impact on the tasks by other tasks, the maximum positive impact of the task on other tasks, the minimum negative impact of the task on other tasks, or any combination thereof. After forming the task groups, the training circuitry generates a corresponding task-grouped RL policy for each task group. As an example, for each task group, the training circuitry trains a corresponding RL model using training data associated with the tasks in the task group to produce a task-grouped RL policy that includes a trained RL model configured to perform the tasks in the task group based on corresponding inputs. As another example, for each task group, the training circuitry produces a task-grouped RL policy indicating which nodes (e.g., devices) in a distributed-learning system are to train the tasks in the task group, which other nodes in a distributed-learning system are to share data (e.g., updated parameters) with the nodes training the tasks in the task group, or both. The training circuitry then distributes the task-grouped RL policies to corresponding implementation systems. By forming the task groups in this way to generate task-grouped RL policies, each task-group RL policy is configured to help an implementation system more accurately and effectively perform corresponding tasks when compared to a general RL model configured to perform all tasks of an implementation system.

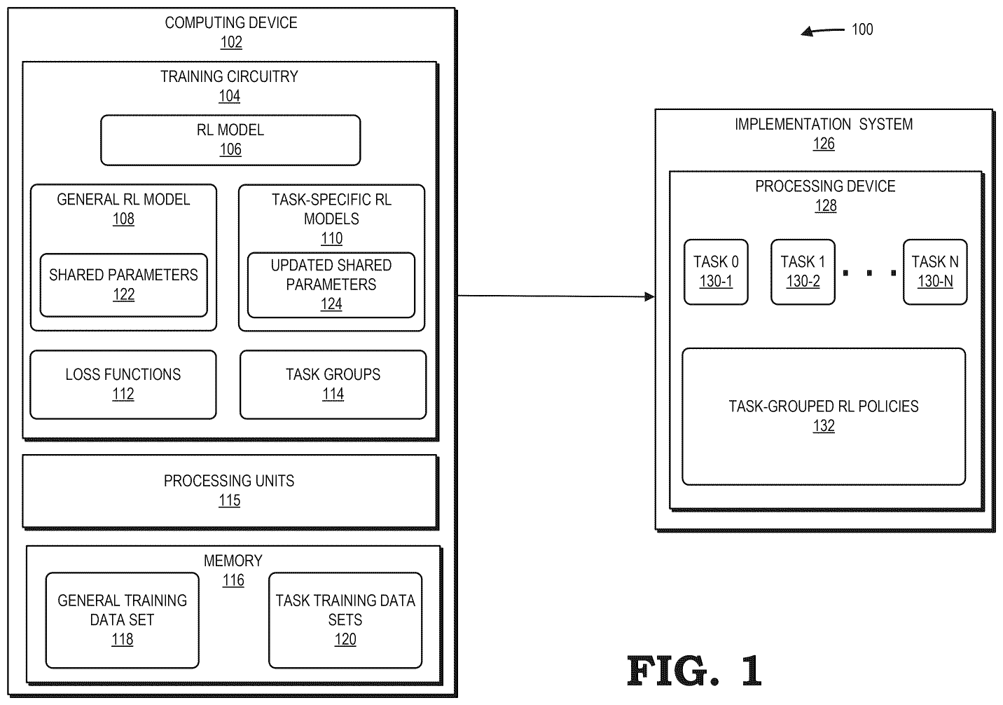

Referring now to FIG. 1, an RL policy system 100 configured to generate and distribute task-grouped RL policies is presented, in accordance with some embodiments. For example, in embodiments, RL policy system 100 includes an implementation system 126 configured to perform one or more tasks 130. Such an implementation system 126, as an example, includes one or more types of systems such as imaging systems (e.g., medical imaging system), robotic systems (e.g., robotic arm platforms), manufacturing systems (e.g., automated manufacturing systems, assembly systems, etching systems), gaming systems (e.g., game consoles, gaming computers), distributed-learning systems (e.g., federated learning systems), autonomous vehicle systems, diagnostic systems, or any combination thereof, to name a few. Further, such tasks 130 performed by the implementation system 126 are based on one or more types of systems included in the implementation system 126. As an example, based on the implementation system 126 including a robotic arm platform, one or more tasks 130 performed by the implementation system 126 include placing an object, removing an object, throwing an object, manipulating the object, or any combination thereof, to name a few. As another example, based on the implementation system 126 including a gaming system, one or more tasks 130 performed by the implementation system 126 include manipulating a player character based on user inputs, managing non-player character actions, frame rendering (e.g., primitive assembly, primitive culling, ray tracing, shading), difficulty scaling, or any combination thereof, to name a few. As yet another example, a distributed-learning system includes various computing devices such as computers, smartphones, tablet computers, laptop computers, and the like (also referred to herein as “nodes”) each configured to perform a corresponding task 130 such as training or updating one or more machine-learning models based on local data, data from one or more other computing devices of the system, or both. Though the example embodiment presented in FIG. 1 shows the implementation system 126 as configured to perform three tasks (130-1, 130-2, 130-N) presenting an N integer number of tasks (where N>0), in other embodiments, implementation system 126 is configured to perform any number of tasks 130.

To perform these tasks 130, implementation system 126 includes processing device 128 configured to implement one or more RL policies (e.g., task-grouped RL policies 132) each including data associated with performing one or more corresponding tasks 130 by, for example, processing device 128. For example, in embodiments, an RL policy includes data indicating one or more trained machine-learning models (e.g., trained RL models) configured to perform one or more corresponding tasks 130 based on receiving corresponding inputs. As another example, an RL policy includes data indicating a node within a distributed-learning system at which a machine-learning model is to be trained for one or more corresponding tasks 130, one or more nodes within the distributed-learning system that are to share data (e.g., parameter updates) with each other, or both. Such a processing device 128, for example, includes a central processing unit (CPU), accelerator unit (AU) (e.g., graphics processing unit (GPU), non-scalar processor, parallel processor, artificial intelligence (AI) processor, inference engine, machine-learning processor, programmable logic device), or both.

According to embodiments, computing device 102 included in or otherwise connected to implementation system 126 is configured to generate and provide one or more RL policies (e.g., task-grouped RL policies 132) to implementation system 126, processing device 128, or both. As an example, in some embodiments, computing device 102 includes a personal computer, server, smartphone, laptop computer, laptop computer, database, or any combination thereof connected to implementation system 126 by one or more networks such as a local area network, wide area network, cellular network, data fabric network, or any combination thereof. As another example, according to some embodiments, computing device 102 includes one or more processing units 115 (e.g., CPUs, AUs) included in or otherwise connected to processing device 128 by one or more buses, data fabrics, or both. Further, computing device 102 includes or is otherwise connected to a memory 116 that or other storage components implemented using a non-transitory computer-readable medium, for example, a dynamic random-access memory (DRAM). In some implementations, memory 116 is implemented using other types of memory including, for example, static random-access memory (SRAM), nonvolatile RAM, and the like.

In embodiments, to generate RL policies, computing device 102 includes training circuitry 104 configured to generate one or more task-grouped RL policies 132. In some embodiments, at least a portion of training circuitry 104 is implemented by processing units 115. Such task-grouped RL policies 132, for example, each include data associated with performing a distinct group of tasks 130 associated with implementation system 126 by processing device 128. Training circuitry 104 is configured to generate one or more task-grouped RL policies 132 by first training RL model 106 based on training data corresponding to each task 130 associated with implementation system 126, represented in FIG. 1 as general training data set 118. Such an RL model 106, for example, includes one or more RL machine-learning models (e.g., policy-based reinforcement models, deterministic models, stochastic models), neural networks, or both configured to perform a set of tasks using a shared set of parameters defined by corresponding training data. Additionally, general training data set 118 includes sets of data associated with each task 130 of the implementation system 126 representing, as an example, one or more inputs to RL model 106 (e.g., states, environmental data) and one or more corresponding (e.g., desired) outputs of RL model 106 (e.g., actions, rewards). Based on the general training data set 118, training circuitry 104 produces a general RL model 108 that includes one or more shared parameters 122 associated with each task 130 of implementation system 126. These shared parameters 122, for example, represent one or more weights, coefficients, biases, cluster centroids, or any combination thereof used when implementing general RL model 108 to determine one or more outputs based on one or more received inputs. That is to say, shared parameters 122 represent one or more weights, coefficients, biases, cluster centroids, or any combination thereof used to perform the tasks 130 of implementation system 126 based on corresponding inputs. Further, training circuitry 104 determines inter-task similarity scores for the tasks 130 represented by general RL model 108 (e.g., the tasks configured to be performed by general RL model 108). These inter-task similarity scores, for example each indicate the impact of training general RL model 108 to perform a first task on the performance of one or more other tasks by general RL model 108. As an example, an inter-task similarity score includes an inter-task affinity score representing an affinity (e.g., degree, or type of impact) between two tasks of general RL model 108, a gradient cosine similarity score representing a similarity between the parameters related to two tasks of general RL model 108, or both.

In embodiments, to determine such inter-task similarity scores, training circuitry 104 is configured to first use one or more loss functions 112. For example, in embodiments, general training data set 118 includes reward functions each indicating a respective reward (e.g., deterministic reward, stochastic reward) for a corresponding task 130 based on a corresponding state (e.g., data indicating an environment) and a corresponding action (e.g., action made in response to the environment). For each task 130, training circuitry 104 uses general training data set 118 to predict the probabilities of one or more actions based on corresponding states indicated the task training data set 120. Using the reward functions of the general training data set 118 associated with the task 130, training circuitry 104 determines a reward (e.g., positive reward, negative reward) for each predicted probabilities of the actions. Based on these rewards, training circuitry 104 determines a loss function 112 that indicates a loss value (e.g., representing a degree of a number of negative rewards) as a function of the predicted actions. Additionally, to determine the inter-task similarity scores, training circuitry 104 is configured to update general RL model 108 based on each task 130 associated with implementation system 126. As an example, for each task 130, training circuitry 104 updates one or more parameters (e.g., shared parameters 122) of general RL model 108 based on a corresponding task training data set 120 associated with the task 130 to produce a corresponding task-specific RL model 110 (e.g., corresponding updated RL model) having one or more updated shared parameters 124. That is to say, based on a corresponding task training data set 120 associated with a task 130, training circuitry 104 produces a corresponding task-specific RL model 110 that represents an update to one or more shared parameters 122 of general RL model 108 based on the task 130. A task training data set 120, for example, includes training data used to train an RL model 106 to perform a corresponding task 130 of implementation system 126.

After determining a corresponding task-specific RL model 110 for a first task 130, training circuitry 104 again uses the loss functions 112 to determine one or more updated loss values for each other task 130 of implementation system 126 (e.g., each task 130 other than the first task 130) from the task-specific RL model 110. That is to say, training circuitry 104 determines the loss values for each other task 130 as indicated by the task-specific RL model 110 (e.g., updated RL model). Training circuitry 104 then compares the loss values of the other tasks 130 from the general RL model 108 to the updated loss values of the task-specific RL model 110 to determine the impact the first task has on each of the other tasks 130. For example, for each other task 130, training circuitry 104 determines a pairwise inter-task similarity score representing the impact of the first task on a corresponding task based on a comparison of the respective loss values and respective updated loss values. After determining the pairwise inter-task similarity scores for the first task indicating the impact of the first task on each other task of general RL model 108, training circuitry 104 determines respective pairwise inter-task similarity scores for each other task 130 based on corresponding task-specific RL models 110.

According to some embodiments, training circuitry 104 is configured to calculate pairwise inter-task similarity scores for each task 130 of RL model 106 (e.g., of implementation system 126) based on a large language model (LLM). For example, training circuitry 104 is configured to first generate data (e.g., strings) representing the name, textual description, or both of each task 130 of implementation system 126. Using the LLM, training circuitry 104 generates contextual embeddings for the names of each task 130, the textual descriptions of each task 130, or both. These contextual embeddings, for example, each include a vector having one or more values that represent the name of a task 130, a textual description of a task 130, or both. Training circuitry 104 then uses a cosine similarity function to determine a similarity between one or more contextual embeddings of a first task and one or more contextual embeddings of a second task with such a similarity representing the pairwise inter-task similarity score between the first task and the second task. In embodiments, this cosine similarity function implemented by training circuitry 104 is represented as:

$$Cosine Similarity ( A , B ) = \frac{( A \cdot B )}{( ‖ A ‖ * ‖ B ‖ )} \qquad [ EQ01 ]$$

wherein A represents a contextual embedding of a first task, B represents a contextual embedding of a second task, A·B represents a dot product between the contextual embedding of the first task and the contextual embedding of the second task, ∥A∥ represents the magnitude of the contextual embedding of the first task, and ∥B∥ represents the magnitude of the contextual embedding of the second task. Using the cosine similarity function, training circuitry 104 determines pairwise inter-task similarity scores for each task such that the pairwise inter-task similarity scores represent the impact of each task 130 on each other task 130 of implementation system 126.

After determining pairwise inter-task similarity scores representing the impact of each task 130 on each other task 130 of implementation system 126 (e.g., of general RL model 108), training circuitry 104 determines one or more task groups 114. Each task group 114 includes a distinct group of one or more tasks 130 of implementation system 126. To determine these task groups 114, training circuitry 104, for each task 130, determines an average similarity score by averaging the pairwise inter-task similarity scores representing an impact of the task, the pairwise inter-task similarity score representing an impact of the task on another task, or both. Training circuitry 104 then forms task groups 114 that maximize the average similarity score for each task 130. That is, training circuitry 104 is configured to form task groups 114 by grouping a respective task 130 with one or more other tasks 130 such that the average similarity score is at a value indicating the least amount of negative impact (e.g., impact that increases a loss value) on the task 130 by other tasks 130, the least amount of negative impact of the task 130 on other tasks 130, the greatest amount of positive impact (e.g., impact that decreases a loss value) on the task 130 by other tasks 130, the greatest amount of positive impact by the task 130 on other tasks 130, or any combination thereof. Using the formed task groups 114, training circuitry generates one or more task-grouped RL policies 132. For example, for each task group 114, training circuitry 104 generates a corresponding task-grouped RL policy 132 that includes data associated with performing the tasks 130 associated with the task group 114. In embodiments, one or more task-grouped RL policies 132 each include data indicating one or more trained machine-learning models (e.g., trained RL models) configured to perform the tasks 130 in the task group 114 corresponding to the task-grouped RL policy 132. As another example, one or more task-grouped RL policies 132 each include data indicating a node within a distributed-learning system at which a machine-learning model is to be trained for the tasks 130 in the task group 114 corresponding to the task-grouped RL policy 132, one or more nodes within the distributed-learning system that are to share data (e.g., parameter updates) with each other, or both. As yet another example, one or more task-grouped RL policies 132 include data indicating grouped tasks 130 for implementation within transfer learning, incremental learning, lifelong learning, or any combination thereof systems.

After generating the task-grouped RL policies 132, computing device 102 provides the task-grouped RL policies 132 to implementation system 126 via a network, data fabric, bus, or any combination thereof. Processing device 128 then performs tasks 130 based on the task-grouped RL policies 132. For example, processing device 128 performs each task associated with a corresponding task-grouped RL policy 132 based on the data indicated in the task-grouped RL policy 132. By using the task-grouped RL policies 132 that only include data for tasks 130 within formed task groups 114, processing device 128 is configured to more accurately and effectively perform the tasks 130 when compared to using a general RL policy that includes data for all tasks 130. That is to say, because the task-grouped RL policies are generated based on task groups 114 formed using pairwise inter-task similarity scores, each task-grouped RL policy 132 introduces less impact (e.g., interference) on the tasks 130 performed by implementation system 126 when compared to a general RL policy that includes data for all tasks 130 to be performed.

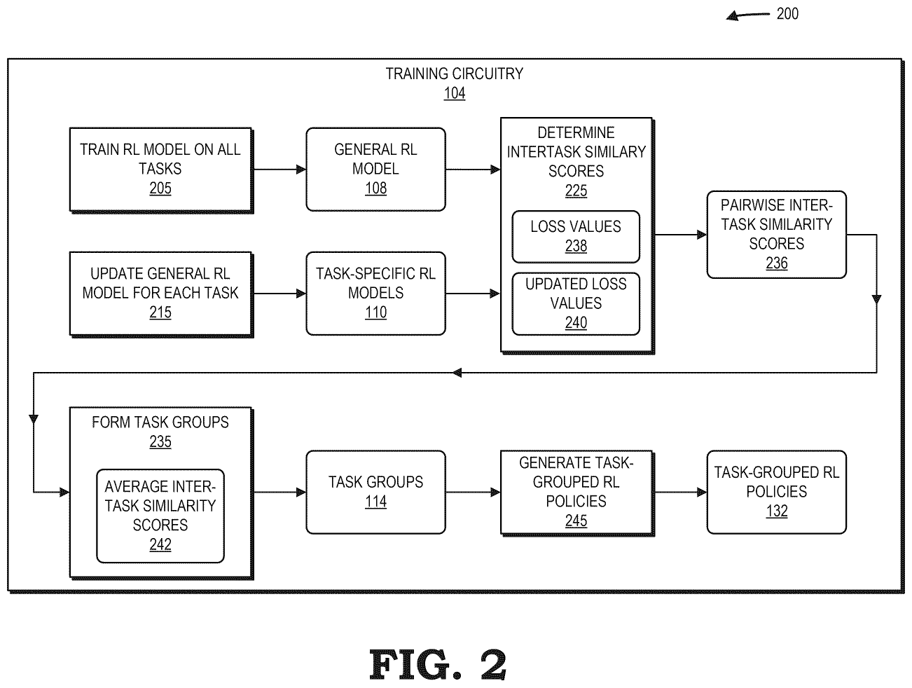

Referring now to FIG. 2, an example operation 200 for generating task-grouped RL policies is presented, in accordance with some embodiments. In embodiments, example operation 200 is implemented at least in part by training circuitry 104. Example operation 200 includes, at block 205, training circuitry 104 training a RL model 106 on all tasks 130 to be performed by an implementation system 126 to produce a general RL model 108. For example, using a general training data set 118 that includes training data associated with each task 130 to be performed by an implementation system 126, training circuitry 104 trains an RL model 106 to produce a general RL model 108 that includes shared parameters 122 for the tasks 130. After producing the general RL model 108, at block 215, training circuitry 104 updates the general RL model 108 for each task 130 to produce corresponding task-specific RL models 110 (e.g., corresponding updated RL models). For example, for each task 130, training circuitry 104 uses a corresponding task training data set 120 with a gradient decent function to update one or more shared parameters 122 of the general RL model 108 to produce a task-specific RL model 110 with one or more updated shared parameters 124 associated with the task 130. At block 225, based on the general RL model 108 and the task-specific RL models 110 produced for each task 130, training circuitry 104 calculates pairwise inter-task similarity scores 236 for each task 130. The pairwise inter-task similarity scores 236 for a task 130 each including one or more values indicating an impact of the task 130 on another corresponding task 130, the impact of another corresponding task 130 on the task 130, a similarity between the task 130 and another corresponding task 130, or any combination thereof. To determine such pairwise inter-task similarity scores 236, in some embodiments, at block 225, training circuitry 104 first determines one or more loss values 238 for each task 130 based on general RL model 108 (e.g., based on the shared parameters 122 of general RL model 108). As an example, using one or more corresponding loss functions 112, general RL model 108 determines one or more loss values 238 that represent a degree (e.g., number, ratio to positive rewards) of negative rewards for predicted actions. In some embodiments, training circuitry 104 is configured to generate one or more loss values 238 by performing one or more operations on one or more other loss values 238. As an example, in some embodiments, training circuitry 104 averages one or more loss values 238 associated with a task 130 to determine an average loss value 238 for the task 130.

Additionally, still referring to block 225, to determine the pairwise inter-task similarity scores 236, training circuitry 104 is configured to determine one or more updated loss values 240 based on corresponding task-specific RL models 110 (e.g., based on corresponding updated RL models). As an example, for a first task-specific RL model 110 associated with a first task (e.g., 130-1), training circuitry 104 determines a first set of updated loss values 240 based on the first task-specific RL model 110, one or more loss functions 112, and the validation data set. In embodiments, this validation set is formed from at least a portion of general training data set 118, one or more task training data sets 120, or both. This first set of updated loss values 240, for example, includes, for each other task 130 than the first task, values representing a difference between one or more observed outputs of the first task-specific RL model 110 and one or more desired outputs indicated in the validation data set each associated with the same input for the task 130. Based on a comparison of corresponding loss values 238 and the respective loss values 240 of the first set of updated loss values 240, training circuitry 104 determines a first set of pairwise inter-task similarity scores 236 that each include one or more values indicating the impact of the first task on another corresponding task 130, a similarity between the first task and another corresponding task 130, or both. For example, in some embodiments, for each other task 130, training circuitry 104 determines a respective pairwise inter-task similarity score 236 that includes one or more inter-task affinity scores. To determine this inter-task affinity score, in embodiments, training circuitry 104 implements a function represented as:

$${Z}_{i \to j}^{t} = 1 - \frac{{L}_{j} ( {X}^{t} , {θ}_{s \vert i}^{t + 1} , {θ}_{j}^{t} )}{{L}_{j} ( {X}^{t} , {θ}_{s}^{t} , {θ}_{j}^{t} )} \qquad [ EQ02 ]$$

wherein Z represents the inter-task affinity score, L represents a corresponding loss function 112, i represents a first task, j represents a corresponding other task 130, X represents a set of validation data (e.g., task training data set 120) associated with the first task, t represents a time,

$${θ}_{s}^{t}$$

represents the shared parameters 122 of general RL model 108,

$${θ}_{s \vert i}^{t + 1}$$

represents the updated snared parameters 124 of the first task-specific RL model 110 associated with the first task, and

$${θ}_{j}^{t}$$

represents the parameters or general RL model 108 and the first task-specific RL model 110 exclusive to the corresponding other task 130. Training circuitry 104 then continues generating pairwise inter-task similarity scores 236 in this way using the task-specific RL models 110 associated with each task 130 until a respective set of pairwise inter-task similarity scores 236 is generated for each task (e.g., a set of pairwise inter-task similarity scores 236 indicating the impact of a corresponding task 130 on each other task 130).

As another example, according to some embodiments, training circuitry 104 is configured to generate one or more pairwise inter-task similarity scores for each task 130 based on the updated shared parameters 124 of a first task-specific RL model 110 associated with the task 130 and the updated shared parameters 124 parameters of a second task-specific RL model 110 associated with a corresponding other task 130. For example, in embodiments, training circuitry 104 is configured to determine a first set of respective pairwise inter-task similarity scores 236 for a first task 130 that includes gradient cosine similarity scores. To determine these gradient cosine similarity scores, in embodiments, training circuitry 104 implements a function represented as:

$${C}_{i \to j}^{t} = \frac{{∇}_{i} {θ}_{s}^{t} \cdot {∇}_{j} {θ}_{s}^{t}}{‖ {∇}_{i} {θ}_{s}^{t} ‖ * ‖ {∇}_{j} {θ}_{s}^{t} ‖} \qquad [ EQ03 ]$$

wherein C represents the gradient cosine similarity score, i represents a first task, j represents a corresponding second task 130, t represents a time,

$${∇}_{i} {θ}_{s}^{t}$$

represents the gradient of the shared parameters 122 or general RL model 108, and

$${∇}_{j} {θ}_{s}^{t}$$

represents the gradient of the parameters of the general RL model 108. Training circuitry 104 then continues generating pairwise inter-task similarity scores 236 in this way using the gradient of the shared parameters 122, the gradient of the updated shared parameters 124 until a respective set of pairwise inter-task similarity scores 236 is generated for each task (e.g., a set of pairwise inter-task similarity scores 236 indicating the impact of a corresponding task 130 on each other task 130). As yet another example, according to some embodiments, training circuitry 104 is configured to generate one or more pairwise inter-task similarity scores for each task 130 based on an LLM. For example, based on an LLM, training circuitry 104 generates contextual embeddings for the names of each task 130, the textual descriptions of each task 130, or both. These contextual embeddings, for example, each include a vector having one or more values that represent the name of a task 130, a textual description of a task 130, or both. Training circuitry 104 then uses a cosine similarity function to determine a similarity between one or more contextual embeddings of a first task and one or more contextual embeddings of a second task with such a similarity representing the pairwise inter-task similarity score 236 between the first task and the second task.

After determining pairwise inter-task similarity scores 236 that represent the impact of each task 130 on each other task 130, a similarity of each task 130 to each other task 130, or both, at block 235, training circuitry 104 is configured to form one or more task groups 114 based on the pairwise inter-task similarity scores 236. For example, for each task 130 of implementation system 126, training circuitry 104 averages the pairwise inter-task similarity scores 236 representing the impact of the task 130 on one or more other tasks 130, the impact of one or more other tasks 130 on the task 130, a similarity between the task 130 and one or more other tasks 130, or any combination thereof to produce an average inter-task similarity score 242 for the task. Training circuitry 104 then groups the tasks 130 into own or more distinct groups based on the average inter-task similarity scores 242 for the tasks 130 to produce the task groups 114. As an example, training circuitry 104 groups the tasks 130 into discrete groups that maximize the average inter-task similarity score 242 for each task 130. That is to say, training circuitry 104 groups the tasks 130 into discrete groups such that the average inter-task similarity score 236 for each task indicates the least amount of impact on the task 130 by other tasks 130 possible for potential task groupings (e.g., potential task groups 114), the least amount of impact by the task 130 on other tasks 130 possible for possible task groupings, or both.

At block 245, training circuitry 104 is configured to generate a corresponding task-grouped RL policy 132 for each formed task group 114. That is to say, for each task group 114, training circuitry 104 generates a task-grouped RL policy 132 that includes data associated with performing each task 130 in the task group 114. As an example, for a task group 114, training circuitry 104 trains one or more machine-learning models (e.g., RL models 106) using task training data sets 120 associated with the tasks 130 in the task group 114 to produce a task-grouped RL policy 132 that includes a trained machine-learning model configured to perform the tasks 130 in the task group 114 based on corresponding inputs. As another example, for a task group 114, training circuitry 104 generates a task-grouped RL policy 132 that includes data indicating which node (e.g., device) within a distributed learning system is configured to train a machine-learning model to perform the tasks in the task group 114, which nodes are to share data (e.g., updated parameters) with the node training this machine-learning model, or both. After generating the task-group RL policies 132, training circuitry 104 provides the task-group RL policies 132 to implementation system 126 via a network, data fabric, bus, or any combination thereof. As yet another example, a task-grouped RL policy 132 includes data indicating grouped tasks 130 for implementation within transfer learning, incremental learning, lifelong learning, or any combination thereof systems.

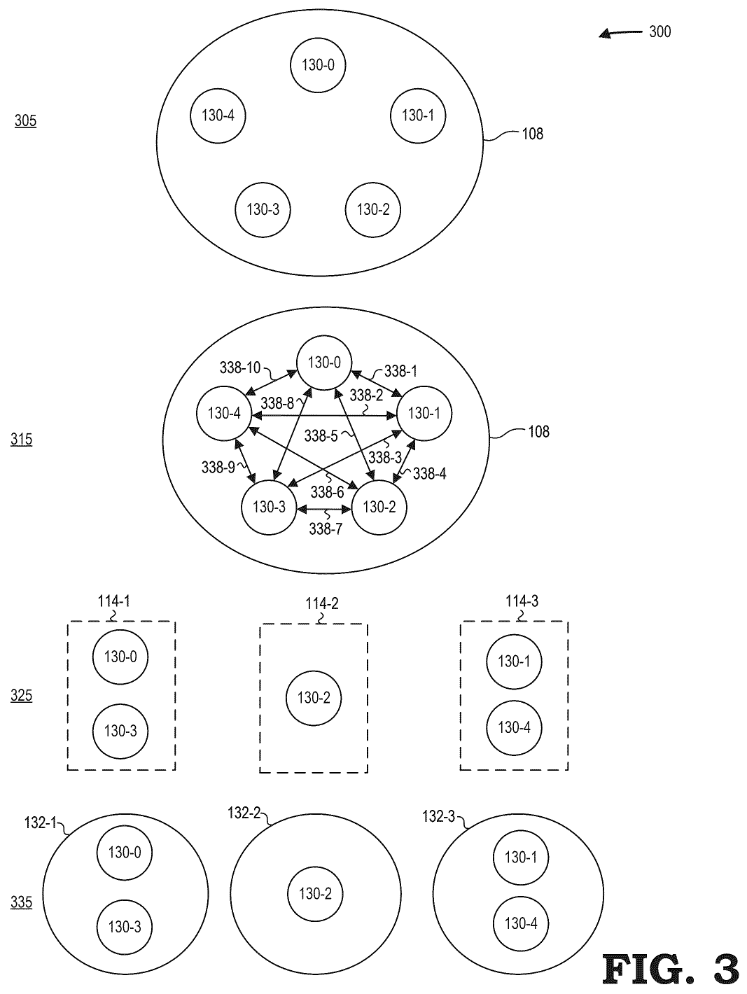

Referring now to FIG. 3, an example operation 300 for grouping tasks based on inter-task similarity scores is presented, in accordance with some embodiments. In embodiments, at least a portion of example operation 300 is implemented by training circuitry 104. A first block 305 of example operation 300 includes training circuitry 104 training an RL model 106 based on each task 130 supported by an implementation system 126 to produce general RL model 108. For example, using a general training data set 118 that includes corresponding pairs of inputs and outputs for each task 130 supported by an implementation system 126, training circuitry 104 trains an RL model 106 to produce a general RL model 108 configured to perform each task 130 based on corresponding inputs. Though the example embodiment presented in FIG. 3 shows training circuitry 104 producing a general RL model 108 configured to perform five tasks (130-0, 130-1, 130-2, 130-3, 130-4) supported by an implementation system 126, in other embodiments, training circuitry 104 is configured to produce a general RL model 108 configured to perform any number of tasks 130 supported by an implementation system 126.

At block 315, training circuitry 104 then determines a pairwise inter-task similarity score 338 for each pair of tasks 130 represented by the general RL model 108. These pairwise inter-task similarity scores 338-1 to 338-10 each represent, for example, the impact a first task has on a second task, the impact the second task has on the first task, a similarity between the first and second task, or any combination thereof. As an example, each pairwise inter-task similarity score 338 includes one or more inter-task affinity scores representing the impact of a first task on a second task, the impact of the second task of the first task, or a combination of the two (e.g., an average). As another example, each pairwise inter-task similarity score 338 includes a gradient cosine similarity representing a similarity between a first task and a second task. According to embodiments, training circuitry 104 is configured to determine these pairwise inter-task similarity scores 338 based on general RL model 108 and one or more task-specific RL models 110. For example, for a first task, training circuitry 104 generates a first set of pairwise inter-task similarity scores 338 that represents the impact of the first task on each other task 130 based on one or more loss values 238 of the other tasks 130 (e.g., loss values associated with general RL model 108) and one or more updated loss values 240 of the other tasks 130 (e.g., loss values associated with the task-specific RL model 110 corresponding to the first task). Additionally, as another example, training circuitry 104 generates a first set of pairwise inter-task similarity scores 338 that represent the similarity between the first task and each of the other tasks 130 based on the updated shared parameters 124 of the task-specific RL model 110 corresponding to the first task and the updated shared parameters 124 of the task-specific RL models 110 corresponding to the other tasks 130.

After generating the pairwise inter-task similarity scores 338, at block 325, training circuitry 104 is configured to form corresponding task groups 114 based on the pairwise inter-task similarity scores 338. For example, for each task 130, training circuitry 104 first determines a corresponding average inter-task similarity score 242 by performing one or more operations on (e.g., averaging) the pairwise inter-task similarity scores 338 representing an impact on the task 130 by other tasks 130, the pairwise inter-task similarity scores 338 representing an impact of the task 130 on other tasks 130, the pairwise inter-task similarity scores 338 representing a similarity between the task 130 and other tasks 130, or any combination thereof. Using these average inter-task similarity scores 242, training circuitry 104 groups the tasks 130 into corresponding task groups 114 such that the average inter-task similarity score 242 for each task 130 represents the least amount of negative impact (e.g., an impact increasing a loss value) on the task 130 by other tasks 130 possible for the potential task groupings (e.g., task groups 114), the least amount of negative impact by the task 130 on other tasks 130 possible for the potential task groupings, the greatest amount of positive impact (e.g., an impact decreasing a loss value) on the task 130 by other tasks 130 possible for the potential task groupings, the greatest amount of positive impact of the task 130 on other tasks 130 possible for the potential task groupings, the most similarity between the task 130 and other tasks 130 possible for the potential task groupings, or any combination thereof. As an example, referring to the example embodiment presented in FIG. 3, training circuitry 104 forms a first task group 114-1 that includes tasks 130-0 and 130-3, a second task group 114-2 that includes task 130-2, and a third task group 114-3 that includes tasks 130-1 and 130-4. Though the example embodiment presented in FIG. 1 shows training circuitry 104 forming a first task group 114-1 including two tasks 130, a second task group 114-2 including one task 130, and a third task group 114-3 including two tasks 130, in other embodiments, training circuitry 104 is configured to form any number of task groups 114 each having any number of tasks 130. At block 335, after forming the task groups 114, training circuitry 104 generates a corresponding task-grouped RL policy (132-1, 132-2, 132-3) for each task group 114. Training circuitry 104 is configured to generate each task-grouped RL policy 132 such that the task-grouped RL policy 132 includes data (e.g., a trained machine-learning model, node information within a distributed learning system) associated with the performance of each task 130 within the task group 114.

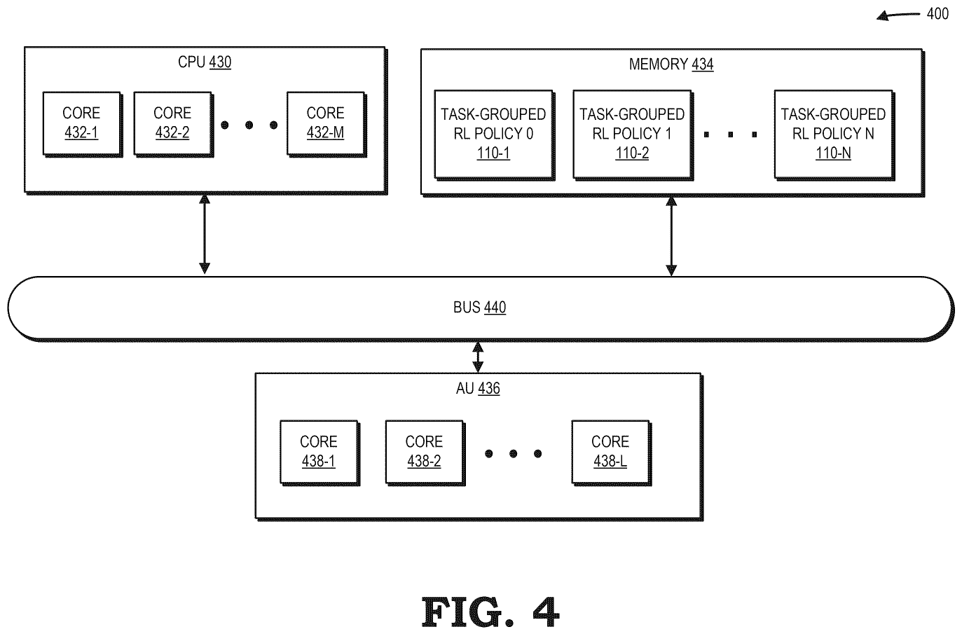

Referring now to FIG. 4, an example implementation system 400 configured to perform multiple tasks based on one or more task-grouped RL policies is presented, in accordance with some embodiments. In embodiments, example implementation system 400 is represented in RL policy system 100 as implementation system 126. According to embodiments, example implementation system 400 includes or has access to memory 434 or other storage components implemented using a non-transitory computer-readable medium, for example, a dynamic random-access memory (DRAM). In some implementations, memory 434 is implemented using other types of memory including, for example, static random-access memory (SRAM), nonvolatile RAM, and the like. Further, memory 434, according to some implementations, includes an external memory to the example implementation system 400. The example implementation system 400 also includes a bus 440 to support communication between one or more components (e.g., CPU 430, AU 436, memory 434) of the example implementation system 400. Some embodiments of example implementation system 400 include other buses, bridges, switches, routers, and the like, which are not shown in FIG. 4 in the interest of clarity. For example, in some implementations, example implementation system 400 includes a data fabric that includes bus 440 and that is configured to support communication between one or more components of the example implementation system 400.

In implementations, example implementation system 400 is configured to perform one or more tasks 130 based on one or more task-grouped RL policies 132. As an example, in some embodiments, example implementation system 400 is configured to perform one or more tasks 130 based on a task-grouped RL policy 132 that includes a trained machine-learning model (e.g., trained RL model) configured to perform the one or more tasks 130 based on corresponding inputs. As another example, according to some embodiments, the example implementation system 400 is configured to train a machine-learning model (e.g., RL model) to perform one or more tasks 130 at a node of a distributed learning system indicated in a task-grouped RL policy 132 associated with the one or more tasks 130. Though the example embodiment of FIG. 4 shows example implementation system 400 as including three task-grouped RL policies (110-1, 110-2, 110-N) representing an N integer number of task-grouped RL policies (where N>0), in other embodiments, example implementation system 400 can include any number of task-grouped RL policies 132.

According to embodiments, to perform one or more tasks 130 based on corresponding task-grouped RL policies 132, example implementation system 400 includes AU 436. AU 436, for example, is configured to operate as one or more vector processors, coprocessors, GPUs, non-scalar processors, highly parallel processors, AI processors, inference engines, machine-learning processors, other multithreaded processing units, scalar processors, serial processors, programmable logic devices (e.g., FPGAs), or any combination thereof. In implementations, AU 436 executes one or more instructions, operations, or both based on one or more task-grouped RL policies 132 to help perform one or more corresponding tasks 130. As an example, AU 436 is configured to execute instructions and operations for one or more trained RL models indicated in a task-grouped RL policy 132 and configured to perform one or more corresponding tasks 130. To perform such instructions and operations, AU 436 implements a plurality of processor cores 438-1, 438-2, 438-L that execute instructions concurrently or in parallel. In some implementations, one or more of the processor cores 438 each operate as one or more compute units (e.g., single instruction, multiple data (SIMD) units) that perform the same operation on different data sets. Though the example implementation illustrated in FIG. 4 AU 436 includes three processor cores (438-1, 438-2, 438-L) representing an L integer number of processor cores (wherein L>0), the number of processor cores 438 implemented in AU 436 is a matter of design choice. As such, in other implementations, AU 436 can include any number of processor cores 438.

Further, example implementation system 400 also includes a CPU 430 that is connected to the bus 440 and therefore communicates with the AU 436 and the memory 434 via the bus 440. CPU 430 implements a plurality of processor cores 432-1 to 432-M that execute instructions concurrently or in parallel. In embodiments, one or more processor cores 432 of CPU 430 are configured to perform one or more instructions, operations, or both based on one or more task-grouped RL policies 132 to help perform one or more corresponding tasks 130. As an example, one or more processor cores 432 of CPU 430 are configured to execute instructions, operations, or both indicated in a trained RL model indicated in a corresponding task-grouped RL policy 132 to perform one or more tasks 130. Though in the example implementation illustrated in FIG. 4 three processor cores (432-1, 432-2, 432-M) are presented representing an M integer number of cores (where M>0), the number of processor cores 432 implemented in CPU 430 is a matter of design choice. As such, in other implementations, CPU 430 can include any number of processor cores 432. In some implementations, CPU 430 and AU 436 have an equal number of processor cores 432, 438 while in other implementations, CPU 430 and AU 436 have a different number of processor cores 432, 438. According to embodiments, CPU 430 is configured to provide data to AU 436 instructing AU 436 to executed one or more instructions, operations, or both for one or more tasks 130 as indicated by a corresponding task-grouped RL policy 132.

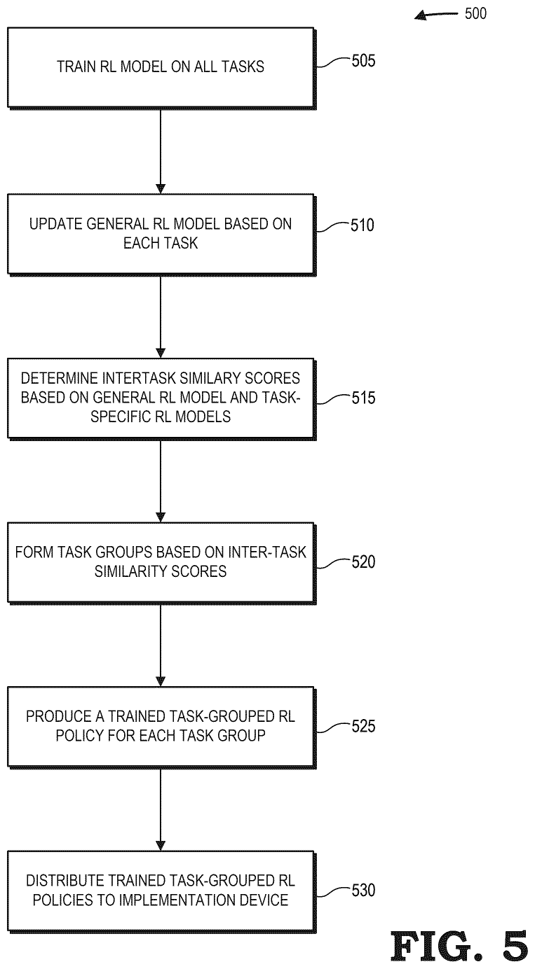

Referring now to FIG. 5, an example method 500 for generating task-grouped RL policies based on pairwise inter-task similarity scores is presented, in accordance with embodiments. In embodiments, at least a portion of example method 500 is implemented at least in part by computing device 102, for example, a processing unit 115 (e.g., CPU, AU) of computing device 102. In embodiments, at block 505 of example method 500 computing device 102 is configured to train an RL model 106 on one or more tasks 130 associated with a corresponding implementation system 126 (e.g., performed by the implementation system 126). As an example, using a general training data set 118 including corresponding pairs of inputs and outputs associated with the tasks 130 of the implementation system 126, computing device 102 trains an RL model 106 to produce general RL model 108 configured to perform the tasks 130 based on corresponding inputs. After generating the general RL model 108, at block 510, computing device 102 is configured to adjust the general RL model 108 based on each task 130 associated with the general RL model 108. For example, for each task 130 associated with the general RL model 108, computing device 102 updates (e.g., based on a gradient descent function) one or more shared parameters 122 of the general RL model 108 based on a task training data set 120 associated with the task 130 to produce a task-specific RL model 110 (e.g., updated RL model) having one or more updated shared parameters 124.

After generating a corresponding task-specific RL model 110 for each task 130 associated with general RL model 108, at block 515, computing device 102 is configured to determine one or more pairwise inter-task similarity scores 236 for each task 130. For example, for each task 130, computing device 102 is configured to determine one or more pairwise inter-task similarity scores 236 based on the general RL model 108 and a task-specific RL model 110 associated with the task. As an example, in some embodiments, computing device 102 first determines, for each task 130, one or more loss values 238 based on the general RL model 108 and one or more loss functions 112. Additionally, for a first task-specific RL model 110 associated with a first task, computing device 102 determines one or more updated loss values 240 for each task 130 other than the first task 130. Based on a comparison of the loss values 238 of the other tasks 130 (e.g., every task but the first task) to the updated loss values 240 of the tasks 130, computing device 102 determines pairwise inter-task similarity scores 236 that represent the impact of the first task 130 on the other tasks 130. For each other task-specific RL model 110, computing device 102 determines updated loss values 240 for the other tasks (e.g., the tasks not associated with the task-specific RL model 110) and compares these updated loss values 240 to the loss values 238 of the other tasks 130 to determine a respective set of pairwise inter-task similarity scores 236 indicating the impact of the task associated with the task-specific RL model 110 on the other tasks. As another example, computing device 102 determines, for each pair of tasks 130, a corresponding pairwise inter-task similarity score 236 representing a similarity between a respective first task and a respective second task, by comparing the updated shared parameters 124 of a task-specific RL model 110 associated with a first task to the updated shared parameters 124 of a task-specific RL model 110 associated with a second task.

Based on the pairwise inter-task similarity scores 236 generated for the tasks 130, at block 520, computing device 102 is configured to group the tasks 130 into distinct task groups 114. For example, for each task 130, computing device 102 determines an average inter-task similarity score 242 based on the determined pairwise inter-task similarity scores 236. The average inter-task similarity score 242 of a task 130, for example, represents the impact of the task 130 on one or more other tasks 130, the impact of one or more other tasks 130 on the task 130, a similarity between the task 130 and one or more other tasks 130, or any combination thereof. According to embodiments, computing device then forms task groups 114 such that the average inter-task similarity score 242 of each task 130 indicates a least amount of negative impact (e.g., impact increasing a loss value) on the task 130 by one or more other tasks possible for potential task groups 114, a least amount of negative impact by the task 130 on one or more other tasks possible for potential task groups 114, a greatest amount of positive impact (e.g., impact decreasing a loss value) on the task 130 by one or more other tasks possible for potential task groups 114, a greatest amount of positive impact by the task 130 on one or more other tasks possible for potential task groups 114, a greatest similarity between the task 130 and one or more other tasks possible for potential task groups 114, or any combination thereof.

After forming task groups 114, at block 525, computing device 102 is configured to generate a corresponding task-grouped RL policy 132 for each task group 114. For example, for a task group 114, computing device 102 trains a machine-learning model (e.g., RL model 106) based on task training data sets 120 associated with the tasks 130 of the task group 114 to produce a task-grouped RL policy 132 that includes a trained machine-learning model configured to perform the tasks 130 of the task group 114 based on corresponding inputs. As another example, for a task group 114, computing device 102 generates a task-grouped RL policy 132 that includes data indicating which node of a distributed learning system is to train a machine-learning model (e.g., RL model 106) configured to perform the tasks 130 in the task group 114, which nodes are to share data (e.g., updated parameters) with the node, or both. After producing a task-grouped RL policy 132 for each task group 114, computing device 102, at block 530, provides the task-grouped RL policies 132 to implementation system 126 via a network, data fabric, bus, or the like.

In some embodiments, the apparatus and techniques described above are implemented in a system including one or more integrated circuit (IC) devices (also referred to as integrated circuit packages or microchips), such as the computing device 102 system described above with reference to FIGS. 1-5. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system comprising:
a computing device having one or more processing units configured to:
train a reinforcement learning (RL) model based on training data associated with a plurality of tasks corresponding to a processing device to produce a general RL model configured to perform the plurality of tasks;
based on the general RL model, group the plurality of tasks into a plurality of task groups; and
generate, for each task group of the plurality of task groups, an RL policy including data associated with performing each task in the task group by the processing device.

2. The system of claim 1, wherein the RL policy for one or more task groups of the plurality of task groups includes a trained RL model configured to perform each task of the task group.

3. The system of claim 1, wherein the RL policy for one or more task groups of the plurality of task groups includes data indicating a node in a distributed learning system associated with the tasks of the task group.

4. The system of claim 1, wherein the one or more processing units are configured to:
for each task of the plurality of tasks, update the general RL model to produce a task-specific RL model; and
produce a plurality of inter-task similarity scores for the plurality of tasks based on the RL model and the task-specific RL models.

5. The system of claim 4, wherein the plurality of inter-task similarity scores include a plurality of inter-task affinity scores for the plurality of tasks.

6. The system of claim 4, wherein the one or more processing units are configured to:
generate, for each task of the plurality of tasks, loss values associated with the general RL model and loss values of one or more task-specific RL models; and
calculate the plurality of inter-task similarity scores based on the loss values associated with the general RL model for each task of the plurality of tasks and the loss values associated with one or more task-specific RL models for each task of the plurality of tasks.

7. The system of claim 4, wherein the one or more processing units are configured to:
group the plurality of tasks into the task groups based on the plurality of inter-task similarity scores.

8. A method comprising:
training a reinforcement learning (RL) model based on training data associated with a plurality of tasks corresponding to a processing device to produce a general RL model configured to perform the plurality of tasks;
based on the general RL model, grouping the tasks into a plurality of task groups; and
generating, for each task group of the plurality of task groups, an RL policy including data associated with performing each task in the task group by the processing device.

9. The method of claim 8, wherein the RL policy for one or more task groups of the plurality of task groups includes a trained RL model configured to perform each task of the task group.

10. The method of claim 8, wherein the RL policy for one or more task groups of the plurality of task groups includes data indicating a node in a distributed learning system associated with the tasks of the task group.

11. The method of claim 8, further comprising:
for each task of the plurality of tasks, updating the general RL model to produce a task-specific RL model; and
producing a plurality of inter-task similarity scores for the plurality of tasks based on the RL model and the task-specific RL models.

12. The method of claim 11, wherein the plurality of inter-task similarity scores include a plurality of gradient cosine similarity scores for the plurality of tasks.

13. The method of claim 11, further comprising:
generating, for each task of the plurality of tasks, loss values associated with the general RL model and loss values of one or more task-specific RL models; and
calculating the inter-task similarity scores based on the loss values associated with the general RL model for each task of the plurality of tasks and the loss values associated with one or more task-specific RL models for each task of the plurality of tasks.

14. The method of claim 11, wherein grouping the plurality of tasks into the plurality of task groups comprises:
grouping the plurality of tasks into the plurality of task groups based on the plurality of inter-task similarity scores.

15. A system, comprising:
a computing device including training circuitry configured to:
for each task of a plurality of tasks associated with a processing device, update a multi-task reinforcement learning (RL) model associated with the plurality of tasks to produce a corresponding updated RL model associated with the task;
group the plurality of tasks into a plurality of task groups based on a plurality of inter-task similarity scores determined from the updated RL models; and
generate, for each task group of the plurality of task groups, an RL policy including data associated with performing each task in the task group by the processing device.

16. The system of claim 15, wherein the RL policy for one or more task groups of the plurality of task groups includes a trained RL model configured to perform each task of the task group.

17. The system of claim 15, wherein the RL policy for one or more task groups of the plurality of task groups includes data indicating a node in a distributed learning system associated with the tasks of the task group.

18. The system of claim 15, wherein the plurality of inter-task similarity scores include a plurality of inter-task affinity scores for the tasks.

19. The system of claim 15, wherein the training circuitry is configured to:
generate, for each task of the plurality of tasks, loss values associated with the RL model and loss values associated with one or more updated RL models; and
calculate the plurality of inter-task similarity scores based on the loss values associated with the RL model for each task and the loss values associated with one or more updated RL models for each task.

20. The system of claim 15, wherein the training circuitry is configured to:
for each task of the plurality of tasks, average one or more inter-task similarity scores of the plurality of inter-task similarity scores to determine an average inter-task similarity score; and
group the plurality of tasks into the plurality of task groups based on the average inter-task similarity scores.
